(19) United States
(12) Patent Application Publication
(10) Pub. No.: US 2020/0074478 A1
(43) Pub. Date: Mar. 5, 2020

(54) SYSTEM, METHODOLOGIES AND EQUIPMENT FOR VALIDATION AND TRACKING OF GOODS

(71) Applicant: Michael H. PETERS, Washington, DC (US)

(72) Inventor: Michael H. PETERS, Washington, DC (US)

(21) Appl. No.: 16/423,415

(22) Filed: May 28, 2019

Related U.S. Application Data
(60) Provisional application No. 62/726,693, filed on Sep. 4, 2018.

(51) Int. Cl. G06Q 30/00; G06Q 10/08

(52) U.S. Cl. CPC G06Q 30/0185; G06Q 10/0831

(57) ABSTRACT

A method of operating a distributed system, the distributed system, and software for the distributed system enable tracking and control of the flow of precious materials across national borders, wherein data regarding physical characteristics of the precious materials gathered at at least one node of a group of nodes to other nodes of the group of nodes, and one or more transactions occurring at at least one node of the group of nodes are tracked, and data identifying the transaction and data identifying the precious materials including physical characteristics of the precious materials gathered at the at least one node are stored at the at least one on node and transmitted to other nodes of the group of nodes along with a certification made by a trusted individual making the transaction regarding validity of the transaction and the stored data.

### CROSS REFERENCE AND PRIORITY CLAIM

This application relies for priority on U.S. Provisional Patent Application Ser. No. 62/726,693, entitled “SYSTEM, METHODOLOGIES AND EQUIPMENT FOR VALIDATION AND TRACKING OF GOODS,” filed on Sep. 4, 2018, the entirety of which being incorporated by reference herein.

### FIELD

Disclosed embodiments pertain to a system and processes that enable the tracking and control of the flow of precious materials (e.g., gemstones) across national borders.

### BACKGROUND

Heretofore, conventional solutions to protect against international smuggling of goods are ineffective. This is particularly true for the smuggling of precious materials such as gemstones. This is partly because precious gems stones such as diamonds, rubies, sapphires, emeralds and the like are often mined from the earth in underdeveloped countries that lack the stable infrastructure to be able to provide consistent monitoring and enforcement of customs and trace regulations. Moreover, in such situations, there is a virtually untraceable supply chain, wherein smuggling is rampant because the likelihood of being caught is far outweighed by the potential gain.

Similar issues are present in the smuggling of legal and illegal drugs, currency, weapons and human trafficking. As a result, all of these smuggling activities are also tied to bribery, theft, violence and terrorism.

Nevertheless, conventional solutions for smuggling and smuggling's precipitative criminal activity remain ineffective. It is commonplace for international border guards to be positioned at official and/or unofficial border crossing routes in an effort to track and apprehend smugglers and smuggled goods. However, such efforts are often unsuccessful either through lack of support, lack of training, lack of infrastructure or lack of motivation. More specifically, bribery of guards and officials is often ubiquitous, thereby resulting in the smuggling of goods being ignored by those charged with protecting against such activities.

Moreover, underdeveloped countries often suffer from porous borders as a result of underdeveloped infrastructure, making unauthorized border crossings easy to accomplish for even the most inexperienced and unprepared organizations and individuals.

Additionally, conventional tax incentives or abatements issued by central governments to induce legal trade registration and export are similarly ineffective because smuggling is, by definition, tax free. Thus, at present, there is little incentive, if any, to be “authorized” to transport, export and/or transact regarding smuggled goods because there is no real benefit to doing so. Further, the detriments to smuggling, i.e., being caught for smuggling, are so speculative and onerous on countries that the laws are essentially unenforceable and ineffective at prohibiting this activity.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Disclosed embodiments provide a system and processes that enable the tracking and control of the flow of precious materials (e.g., gemstones) across national borders.

In accordance with at least some embodiments, the system and processes provide mechanisms for providing a tamper-proof chain of custody protocol.

In accordance with at least some embodiments, the system and processes utilize photographic imaging technology that enables creation of photographic identification (ID) data for the precious materials.

In accordance with at least some embodiments, the system and processes utilize numerical ID tagging to create a digital record for associating all other identification data and for tracking the precious materials through the supply chain.

In accordance with at least some embodiments, the system and processes utilize one or more digital fingerprinting technologies to generate data indicating, and, therefore, identifying various characteristics of the precious materials. Such technologies may include but are not limited to three-dimensional scanning, chemical spectrometry, InfraRed (IR) scanning, Raman scanning, etc.

In accordance with at least some embodiments, the system and processes utilize a blockchain database to track and validate movement and/or transfer of precious materials.

### BRIEF DESCRIPTION OF THE FIGURES

FIG. 1 illustrates an example of operation and functionality provided in accordance with disclosed embodiments.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Disclosed embodiments provide a system and processes that enable the tracking and control of the flow of precious materials (e.g., gemstones) across national borders. To understand the difficulty associated with precious materials such as gemstones, ivory, furs, jewelry, art or other high value materials of finite size and quantity, consider the countries of the Middle East. That region successfully converted its sand into sky scrapers and free education by using its natural resources, i.e., oil, for national betterment. However, oil is difficult to smuggle because of the quantity required to move and the infrastructure required to move it. Disclosed embodiments are directed at altering the way that high value, finite sized, easily transportable precious materials enter the international marketplace so as to enable nations rich in those materials to similarly reap the benefits of their resources.

As a result, the disclosed embodiments provide a solution for anti-smuggling of the several trillions of dollars of minerals that can easily be used for smuggling and the resultant laundering, weapons, human trafficking, drugs, and bribery.

In accordance with at least some embodiments, the system and processes provide mechanisms for provided a tamper-proof chain of custody protocol that enables verifiable validation of the identity of the goods to such certainty that trading of those goods can be performed in a way that does not warrant the need to actually have possession of the physical goods themselves.

Such a technical innovation is particularly valuable in the market for colored gemstones, which includes mines, and industry participants who are geographically diverse, with no or very few market dominant players that can dictate market operation to other market participants. This is completely different than the highly structured diamond industry. Conventionally, systems, methodologies and protocols are in place for managing and controlling supply of particular precious materials, in particular, diamonds, wherein the market is highly structured, standardized and ownership and market dominance enable a limited number of market participants to dictate how the entire market operates. Thus, where the diamond industry is largely controlled a very limited number of market participants, the colored gemstone industry is significantly more diverse and unstructured. As a result, the colored gemstone market lacks the structure and stability resulting from a single, large player that enforces record keeping and chain of custody practices.

In accordance with at least some embodiments, the system and processes utilize photographic imaging technology that enables creation of photographic identification (ID) data for the precious materials.

In accordance with at least some embodiments, the system and processes utilize numerical ID tagging to create a digital record for associating all other identification data and for tracking the precious materials through the supply chain.

In accordance with at least some embodiments, the system and processes utilize a blockchain database to track and validate movement and/or transfer of precious materials.

As is understood in the technology, the term “blockchain” refers to the practice of using and cryptographically linking an increasing number of records, conceptually thought of as “blocks” to store data in a way that enables dissemination and public access to that data in a verifiable and immutable way. Each block contains a cryptographic hash of a previous block, a timestamp, and transaction data that, in the presently disclosed embodiments, may include the ID data generated at points along the supply chain. Disclosed embodiments utilize blockchain because it is resistant to modification of the data, thereby protecting the data from alteration. However, disclosed embodiments also benefit from the open, distributed nature of the resulting ledger because the implementation can be used to record transactions between parties efficiently and in a verifiable and permanent way

As a result, the disclosed embodiments utilize blockchain to provide a peer-to-peer network for memorializing and verifying transactions and identity associated with a particular item of precious material so as to enable inter-node communication and validation of new blocks. Because the recorded data in any given block cannot be altered retroactively without alteration of all subsequent blocks, alteration is implicitly limited unless a consensus of market participants agrees. Thus, this implementation makes data corruption extremely difficult if not impossible.

This blockchain solution for anti-smuggling promotes fair trade for the workers, appropriate revenue for nations and villages, anti-drug, anti-cartel, anti-human trafficking, anti-weapons, anti-money laundering. Moreover, use of a distributed, immutable cryptographic photographic image data and text smart-contract database ledger enables the ability to identify the origin and path of each item of precious material whether it be a gemstone, ivory or fur or valuable. The distribution of the data in this way makes it 100% unalterable.

Establishing such a database enabled supply chain requires special methods for linking the precious material to its digital tag: “fingerprint” or “dna” and traced, time-stamped and verified chain of custody. For example, in disclosed embodiments, a traceable history of the precious material's journey is created from origin to end customer, with key nodes contributing various additional data including smart contracts, microscope and “fingerprint” or “dna” of the precious material, viewable on a D-App (Distributed App to unencrypt secure information) at any point during the supply chain journey.

The technical value of this implementation is best understood given an example. Under the protocol of the disclosed embodiments, all goods without a blockchain record are suspected, therefore, to be unauthorized and likely smuggled, e.g., “blood” or criminally-sourced, non-Fair Trade, unethically sourced gemstones.

Implementation of blockchain technology, in combination with other aspects of the disclosed embodiments enables creation of a tamperproof chain of custody for the actual precious materials from origin to any location within the supply chain including mines, factories, clearing houses, laboratories, show rooms, etc.

For example, working with the example of a gemstone, at the mining site, certain identifying characteristics may be measured including weight, dimensions and composition of the precious material. For example, with regard to gemstones, a stone may be imaged using high definition macro photography, spectrometric imaging, thermographic scanning or other means of unique identity or tagging parts or all of the gemstone.

In accordance with at least some embodiments, location information may be included in data associated with the gemstone. Such location information may be generated, for example, using one or more Global Positioning System (GPS) sensors that may be included, or affixed to a package including the gemstone. Such packages may be, for example, sealed in a tamper proof manner, wherein the sensor is activated as part of the sealing or unsealing operation.

In accordance with at least some embodiments, such location information may be monitored in association with the other data relating to the location or environment of the gem stone so as to provide a more complete history regarding the sourcing of the gem stone. Thus, for example, a variety of sensors may be placed inside the sealed package, each of which may collect a different kind of data, e.g., tracking the motion and location of the parcel. Sensor types may include, for example, barometric pressure sensors, non-GPS based location sensor, etc. Additionally, a Radio Frequency IDentification (RFID) tag may be included and/or a fraud-deterred unique QR code with embedded info. It should be appreciated that package couriers/carriers may not be aware of the function of the various sensors; however, if all sensors do not arrive with the package when it is checked into a next location, e.g., a processing laboratory, the contents of the package may be considered off-blockchain, and, therefore, less or non-verified.

In accordance with at least some embodiments, the system and processes utilize one or more digital fingerprinting technologies to generate data indicating, and, therefore, identifying various characteristics of the precious materials. Such technologies may include but are not limited to three-dimensional scanning, chemical spectrometry, InfraRed (IR) scanning, Raman scanning, etc.

Following such inventory identification techniques, the gem stone may be sealed in a tamperproof Radio Frequency Identification (RFID) tagged container, such as a bag or box.

Thereafter, transportation of the gemstone to the lab will involve transport through one or more checkpoint nodes, wherein the inventory identification data is rechecked and compared with previously the previously obtained inventory identification data to verify identity of the gemstone.

Moreover, it should be understood that such checkpoint nodes may also include identification of people in possession of the gemstone and/or processing the gemstone. Possible checkpoint locations for ID check-points may include, for example, mine locations, village central clearing houses, local laboratories, customs export locations, storage facilities, etc. Additionally, it should be understood that an ID check may be performed, for example, at any time rough goods are transacted, customs import processing, when goods are sorted or divided for processing, prior to cutting, as part of or in conjunction with certification after cutting, any time finished goods are transacted, etc.

In connections with such ID check, trusted individuals may be requested or required to sign off on one or more certifications, for example, consider an example of a certification for a village elder: “I certify that these gemstones are ethically sourced and the result of fair trade practices. All people involved in the mining, processing, and sale of these gemstones participated voluntarily, worked under healthy and safe conditions, and received fair pay. This transaction has contributed to economic development, prosperity, and peace for our village, region, and nation. Thank you for partnering in our growth and success.” Thus, it should be understood that the trusted individual may be an individual trusted and/or of authority at the checkpoint node location, e.g., a village, a mine, a laboratory, etc.

Thus, it should be understood that the checkpoint nodes may be viewed as nodes used in a blockchain configuration that enable processing of transactions for processing the gemstone as it travels through the supply chain an into the market place. As the gemstone travels through the supply chain, its various characteristics may be checked at various transportation checkpoints or supply chain nodes, wherein, for example, analysis is performed to determine weight, visual validations, data validation and RFID scanning so as to validate and verify the precious material's identity. Furthermore, once a gemstone arrive at a laboratory node in the supply chain, various specific identification technology is utilized to determine weight, and image data generated by, for example, high definition macro photography, scanning including RFID scanning, spectrometry, or other identifying techniques depending on the item of value being registered.

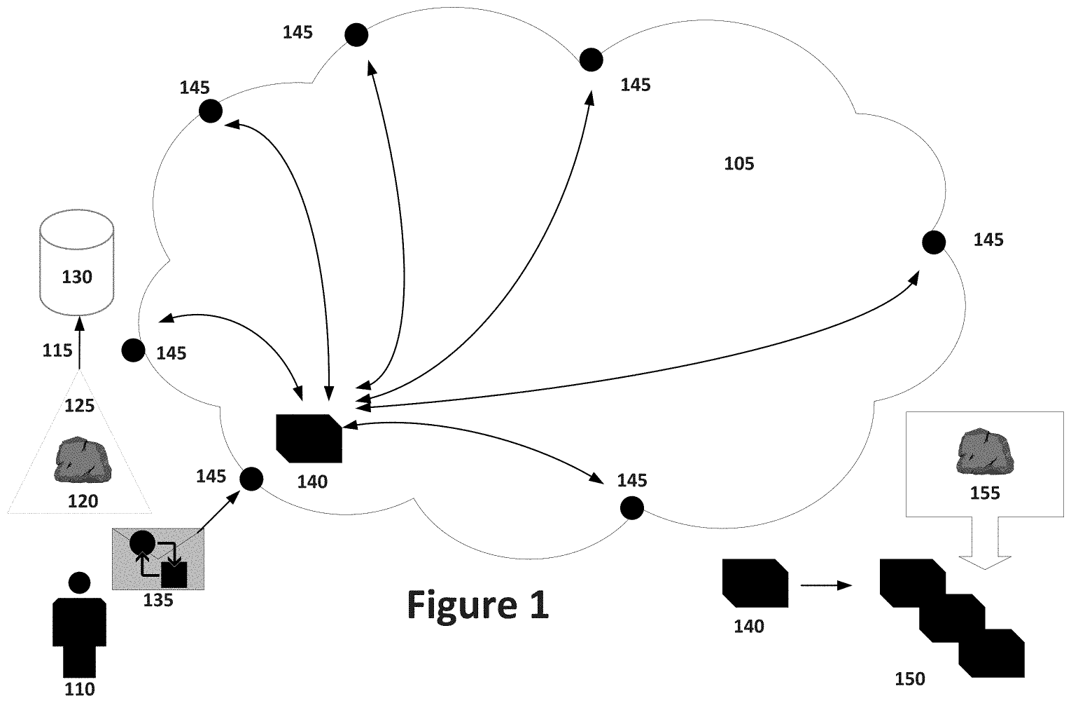

Thus, for example, as shown in FIG. 1, consider that, using a blockchain network 105, a user 110 requests a transaction 115 to transfer a gemstone 120 from a mine 125 into a village repository 130. That request 135 triggers generation of a block 140 representing the transaction 115. That block 140 may then be transmitted, or broadcast, to other nodes 145 in the blockchain network 105 (for example, all the nodes or some portion of the nodes). Thereafter, the other nodes 145 may validate the block 140, and, therefore, the transaction 115. The block 140 is then added to the chain 150 associated with the gemstone 120 and the transaction 115 is verified and executed. In this example, it should be readily apparent that all the transactions associated with the gemstone 120, and additionally, gemstone specific ID data 155 generated as part of those transactions and associated processing, may be managed, maintained and validated across the entire supply chain.

It should be understood that the fingerprinting techniques used to identify the precious material will depend on the nature of the material, e.g., gemstone v. fur, as well as the stage of manufacture at which the material is during identification, e.g., different characteristics will be measured depending on whether a gemstone has been cut yet or is raw from the mine.

Thus, continuing with the gemstone example, fingerprinting of a gemstone may include microscope photography (e.g., front-lighting for profile, back/side lighting for internal inclusions, multiple perspective imaging and various scanning techniques and non-invasive tagging techniques, dependent on the item of value being entered on the blockchain. Additionally, 3D modeling may be performed including optical 3D scanning resulting in a Computer Aided Design (CAD) file for the gemstone exterior envelope and internal inclusions. Laser Ablation Inductively Coupled Mass Spectrometry (LAICMS) may be performed to provide a detailed chemical composition of the gemstone. Use of a Raman scan may also provide spectral analysis. Likewise, use of IR scanning can capture infrared images at specified intervals by applying gentle heat so as to capture the way heat travels through the stone. A radioactive tracker may also be applied, wherein light radiation is applied to make minor molecular rearrangements. The stone does not take on radioactive properties; however, an atomic signature is left by the temporary exposure to radiation.

In a similar set of analytical measures, cut Gemstone identification performed at or following processing at a laboratory may include microscope photographic imaging including front-lighting for profile, back/side lighting for internal inclusions and multiple perspective imaging as well as 3D modeling, for example, optical 3D scan resulting in a CAD file for the stone exterior envelope and internal inclusions, Raman scan (spectral analysis), and an IR scan (to capture infrared images at specified intervals to capture the way heat travels through the stone. With this information, a correlation score may be determined based on statistical analysis of the before-processing and after-lab results.

As a result, a “fingerprint match” or “DNA match” score may be computed based on the result comparison and available on the D-App at any point in the immutable history of the product. Such a score may be readily available to an end user, buyer, retailer, wholesaler, government, or regulators to confirm authentication and validation of the precious material.

In accordance with at least some disclosed embodiments, a specialized blockchain structure includes data storage with hash pointers to encrypted distributed servers for speed of D-App performance and secure data of any size to enhance speed but not “bloat” the blockchain. More specifically, this should reduce the risk of network congestion so as to minimize transaction backlogs without needing usage fees.

As a result, the inventive protocol enables currency transfer across international borders, and appropriate duties and regulation adherence. With a time stamped chain of custody, smart contracts may be readily executed to transfer of ownership and release escrowed funds. As a result, systems, methodologies and software may be used to implement or used in combination with an electronic trading platform, wherein electronic identity associated with precious materials, e.g., a particular gemstone, enables authenticated trading of the gemstone, without physical change of possession. In this way, gemstones used for investment purposes can be electronically traded like gold and other precious commodities, without the cost and difficulty of physically exchanging the gemstones themselves. Such an implementation is commercially meaningful because higher prices can be commanded for verified and validated materials as a result of an enlarged marketplace and increased market liquidity.

As a result of the above described utility, various real world benefits are produced. For example, the disclosed embodiments provide a technical mechanism for establishing, monitoring, confirming and communicating undisputable proof of ethical chain of custody from mine to jewelry, or end use, depending on the nature and value of a particular item. The commercial value of such a technical improvement is evident based on the fact that ethically sourced, fair trade stones are acceptable on the world market, while unethical stones are rejected by the market or given a heavily discounted value.

By blockchain registering precious material, e.g., gemstones, ivory, a rare painting or other items of value as part of bringing those items to the international marketplace, the resulting value increases because illegal stones resulting from smuggling are readily recognized in the market place based on the lack of blockchain certification. This utility, in turn, enables national governments and international regulatory agencies to monitor the flow of a nation's national resources while providing market benefit to miners or traders in a particular nation. As a result, at a nation level, an economy may be boosted by legal gem trading and exporting rather than drained by smuggling and other associated illicit activity.

In accordance with various embodiments, technical and logistical utility is provided because, in combination, the various components described above provide an efficient and readily implementable way to monitor and control the flow of precious materials, such as gemstones, across national borders. As a result, further utility is provided by with regard to customs and trade regulation. For example, various aspects of the disclosed embodiments enable the establishment of an ethically sound, safe, chain of custody protocol. Such a protocol, when practiced in a particular industry, may enable the ability or increase the likelihood of being able to exclude terrorist and organized crime groups from participating in the trade of goods

Accordingly, in accordance with at least some embodiments, the system and processes may enable the ability or increase the likelihood of being able to ensure that a local population within an area where the precious materials are mined or harvested receives fair trade compensation for their work. Additionally, the reliability provided by the system and processes may further create revenue for the local and national economy of that local population and increase the resale value of the precious materials on a national or international market basis since the goods can be verified ethical and fair trade compliant.

In accordance with at least some embodiments, the system and processes may enable the ability or increase the likelihood of being able to increase the value of the precious materials, e.g., gemstones because the disclosed embodiments may incentivize those who would have smuggled goods across a border or sold them illegally to now participate in a legal customs and trade process. As a result, additional utility may further be provided because implementation of such a process may assist in maintaining revenue from precious material national resources in their home country.

In accordance with at least some embodiments, the system and processes may enable the ability or increase the likelihood of being able eliminate or reduce corruption associated with customs and trade processes because, in implementation, conceivably, every movement of the precious materials can be tracked and validated using a blockchain database.

In accordance with at least some disclosed embodiments, the data collected and stored for a precious material item may optionally include humanization and verification data, for example, photographic images of the mine and/or miner and/or village leaders associated with the item, e.g., the miner who mined the gemstone. Likewise, photographic images of the individuals and locations where the gemstone is processed may be included as well.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, additional utility of the disclosed embodiments is provided based on the additional market value for goods introduced into a market place via the blockchain supply chain nodal verification implementation of the disclosed embodiments. Thus, it should be understood that implementation or use of the disclosed embodiments rewards those who bring their “fingerprinted” products (e.g., gemstones, furs, ivory, etc.) into the marketplace using the disclosed embodiments. Further, adoption of the disclosed embodiments by supply chain and marketplace participants is also rewarded as a result of the increased value inured to the products they process as a result of the detailed nodal checkpoints that sum to provide a verified timeline from origin to consumer via blockchain immutable auto-executing Smart Contracts. As a result, implementation of the disclosed embodiments to the chain of custody for precious materials further eliminates not only smuggling but also the associated illegal activities including money laundering, drug smuggling and distribution, organized crime, human trafficking, etc.

In accordance with at least one embodiment, the system, methodologies and components and software may be used to monitor and confirm the validity of precious material throughout a supply chain, and, optionally, export fees may be rebated, or some other fiat or crypto currency reward, to a party provided their product travels end-to-end in its supply chain in accordance with the disclosed invention.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

It should be understood that various aspects of the disclosed embodiments and the disclosed functionality are implemented using software running on a plurality of networked computers.

It should further be understood that various connections are set forth between elements in the description herein; however, these connections in general, and, unless otherwise specified, may be either direct or indirect, either permanent or transitory, and either dedicated or shared, and that this specification is not intended to be limiting in this respect.

Additionally, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on a plurality of general purpose equipment via software implementations providing the functionality described herein. Thus, it should be understood that components disclosed herein may be used in conjunction with, as described above, other components, for example a computer processor.

It should be understood that the operations explained herein may be implemented in conjunction with, or under the control of, one or more general purpose computers running software algorithms to provide the presently disclosed functionality and turning those computers into specific purpose computers.

Moreover, those skilled in the art will recognize, upon consideration of the above teachings, that the above exemplary embodiments may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out the above-described method operations and resulting functionality. In this case, the term non-transitory is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

While certain illustrative embodiments have been described, it is evident that many alternatives, modifications, permutations and variations will become apparent to those skilled in the art in light of the foregoing description. Accordingly, the various embodiments of, as set forth above, are intended to be illustrative, not limiting. Various changes may be made without departing from the spirit and scope of the invention.

As a result, it will be apparent for those skilled in the art that the illustrative embodiments described are only examples and that various modifications can be made within the scope of the invention as defined in the appended claims.

We claim:

1. A distributed system for tracking and control of the flow of precious materials across national borders, the system comprising:
software installed on specific or general purpose computers included in a plurality of nodes that enables communication of data regarding physical characteristics of the precious materials gathered at at least one of the plurality of nodes to other nodes of the plurality of nodes,
wherein the plurality of nodes are coupled together via one or more communication networks to provide communication among the plurality of nodes regarding the data gathered by the plurality of nodes,
wherein the software tracks one or more transactions occurring at at least one node of the plurality of nodes, stores data identifying the transaction and data identifying the precious materials including physical characteristics of the precious materials gathered at the at least one node and transmits the stored data to other nodes of the plurality of nodes for validation by the other nodes, and
wherein the stored data is included in a block which is transmitted to other nodes of the plurality of nodes to be included in a chain of blocks associated with the precious materials that evidences a chain of transactions for the precious materials across at least one national border, indicating authenticity of the precious materials and the physical characteristics of the precious materials to enable authentication of the precious materials by a purchaser of the precious materials.

2. The distributed system for tracking and control of the flow of precious materials across national borders of claim 1, wherein the software transmits the stored data to other nodes of the plurality of nodes for validation by the other nodes along with a certification made by a trusted individual making the transaction regarding validity of the transaction and the stored data.

3. The distributed system for tracking and control of the flow of precious materials across national borders of claim 1, wherein the block chain provides a mechanism for providing a tamper-proof chain of custody protocol for the precious materials.

4. The distributed system for tracking and control of the flow of precious materials across national borders of claim 1, wherein data indicating physical characteristics of the precious material includes weight of the precious material as well as data generated using photographic imaging technology that enables creation of photographic identification data (ID) for the precious materials.

5. The distributed system for tracking and control of the flow of precious materials across national borders of claim 1, wherein stored data includes numerical ID tagging to create a digital record for associating all other identification data and for tracking the precious materials through a supply chain to the customer.

6. The distributed system for tracking and control of the flow of precious materials across national borders of claim 1, wherein the stored data is generated using one or more digital fingerprinting technologies to generate data indicating and identifying physical characteristics of the precious materials.

7. The distributed system for tracking and control of the flow of precious materials across national borders of claim 1, wherein the one or more digital fingerprinting technologies include at least one of three-dimensional scanning, chemical spectrometry, InfraRed (IR) scanning, and Raman scanning.

8. The distributed system for tracking and control of the flow of precious materials across national borders of claim 1, wherein the blockchain is stored in a database at all of the plurality of nodes and is used to track and validate movement and/or transfer of the precious materials.

9. A method of tracking and controlling flow of precious materials across national borders using a distributed system, the method comprising:
operating software installed on specific or general purpose computers included in a plurality of nodes that enables communication of data regarding physical characteristics of the precious materials gathered at at least one of the plurality of nodes to other nodes of the plurality of nodes, wherein the plurality of nodes are coupled together via one or more communication networks to provide communication among the plurality of nodes regarding the data gathered by the plurality of nodes,
storing, by the software tracks one or more transactions occurring at at least one node of the plurality of nodes, data identifying the transaction and data identifying the precious materials including physical characteristics of the precious materials gathered at the at least one node and transmits the stored data to other nodes of the plurality of nodes for validation by the other nodes; and
including the stored data in a block which is transmitted to other nodes of the plurality of nodes to be included in a chain of blocks associated with the precious materials that evidences a chain of transactions for the precious materials across at least one national border, indicating authenticity of the precious materials and the physical characteristics of the precious materials to enable authentication of the precious materials by a purchaser of the precious materials.

10. The method of tracking and control of the flow of precious materials across national borders of claim 9, wherein the software transmits the stored data to other nodes of the plurality of nodes for validation by the other nodes along with a certification made by a trusted individual making the transaction regarding validity of the transaction and the stored data.

11. The method of tracking and controlling flow of precious materials across national borders of claim 9, wherein the block chain provides a mechanism for providing a tamper-proof chain of custody protocol for the precious materials.

12. The method of tracking and controlling flow of precious materials across national borders of claim 9, wherein data indicating physical characteristics of the precious material includes weight of the precious material as well as data generated using photographic imaging technology that enables creation of photographic identification data (ID) for the precious materials.

13. The method of tracking and controlling flow of precious materials across national borders of claim 9, wherein stored data includes numerical ID tagging to create a digital record for associating all other identification data and for tracking the precious materials through a supply chain to the customer.

14. The method of tracking and controlling flow of precious materials across national borders of claim 9, wherein the stored data is generated using one or more digital fingerprinting technologies to generate data indicating and identifying physical characteristics of the precious materials.

15. The method of tracking and controlling flow of precious materials across national borders of claim 9, wherein the one or more digital fingerprinting technologies include at least one of three-dimensional scanning, chemical spectrometry, InfraRed (IR) scanning, and Raman scanning.

16. The method of tracking and controlling flow of precious materials across national borders of claim 9, wherein the blockchain is stored in a database at all of the plurality of nodes and is used to track and validate movement and/or transfer of the precious materials.

17. A non-transitory computer readable medium including software instructions, which, when executed by a specific or general purpose computer, perform a method of tracking and controlling flow of precious materials across national borders using a distributed system, the method comprising:
operating software installed on specific or general purpose computers included in a plurality of nodes that enables communication of data regarding physical characteristics of the precious materials gathered at at least one of the plurality of nodes to other nodes of the plurality of nodes, wherein the plurality of nodes are coupled together via one or more communication networks to provide communication among the plurality of nodes regarding the data gathered by the plurality of nodes,
storing, by the software tracks one or more transactions occurring at at least one node of the plurality of nodes, data identifying the transaction and data identifying the precious materials including physical characteristics of the precious materials gathered at the at least one node and transmits the stored data to other nodes of the plurality of nodes for validation by the other nodes; and
including the stored data in a block which is transmitted to other nodes of the plurality of nodes to be included in a chain of blocks associated with the precious materials that evidences a chain of transactions for the precious materials across at least one national border, indicating authenticity of the precious materials and the physical characteristics of the precious materials to enable authentication of the precious materials by a purchaser of the precious materials.
